(19) United States
(12) Patent Application Publication
(10) Pub. No.: US 2017/0363152 A1
(43) Pub. Date: Dec. 21, 2017

(54) CONSTANT VELOCITY JOINT COMPRISING INTEGRAL INTERNAL JOINT PART AND METHOD FOR PRODUCING SUCH A CONSTANT VELOCITY JOINT

(71) Applicant: IFA-Technologies GmbH, Haldensleben (DE)

(72) Inventors: David SCHMICKER, Magdeburg (DE); Andreas KRUEGER, Schoenebeck/Elbe (DE); Martin SCHMIDT, Haldensleben (DE)

(73) Assignee: IFA-Technologies GmbH, Haldensleben (DE)

(21) Appl. No.: 15/626,245

(22) Filed: Jun. 19, 2017

(30) Foreign Application Priority Data
Jun. 21, 2016 (DE) 10 2016 007 495.7

(51) Int. Cl. F16D 3/226; F16D 1/068; F16D 3/84; F16D 3/223

(52) U.S. Cl. CPC F16D 3/226; F16D 3/845; F16D 1/068; F16D 2250/0053; F16D 2250/0084; F16D 2003/22323

(57) ABSTRACT

A constant velocity joint includes an external joint part including internal ball tracks, an internal joint part including external ball tracks assigned to the internal ball tracks, and a ball cage holding balls. The external joint part is connectable to a connecting part and sealed by a closure cap on the side facing this connecting part. The internal joint part is an integral internal joint part connected permanently to a shaft piece, sealed on this side towards the external joint part by a flexible sealing element, hardened, and has a protruding welding attachment for an adapter on its free end. The welding attachment outer diameter is larger than the smallest integral internal joint part outer diameter. In a method, the sealing element is mounted over the integral internal joint part free end and connected to the external joint part, the adapter subsequently welded near the welding attachment.

### CROSS REFERENCE TO RELATED APPLICATIONS

Applicant claims priority under 35 U.S.C. §119 of German Application No. 10 2016 007 495.7 filed Jun. 21, 2016, the disclosure of which is incorporated by reference.

### BACKGROUND OF THE INVENTION

### 1. Field of the Invention

The invention is based on a constant velocity joint comprising an integral internal joint part as well as on a method for producing such a constant velocity joint.

### 2. Description of the Related Art

Constant velocity joints comprising integral internal joint parts are already known. On principle, they have the same setup as common constant velocity joints. In contrast to common constant velocity joints, however, the internal joint part forms an integral, i.e. destruction-free, permanent connection with a shaft piece, which is to be connected in a rotationally fixed manner to an adjacent component, a so-called connecting part. Compared to a multi-part connection between joint and adjacent component, for example a shaft-hub connection comprising profiled toothing and axial securing means, such an integral connection also provides for a reduction of the assembly effort when installing the constant velocity joints into drive trains of motor vehicles, in addition to the advantage of a weight reduction of the connection. Based on this principle, a method for producing an intermediate shaft comprising an integral ball hub is known, in the case of which a shaft piece and the internal joint part of a constant velocity joint are welded together, wherein, depending on the shape of the shaft, an annular collar or a journal attachment, on which the welding connection is carried out, is integrally molded on the internal joint part. After establishing the welded connection, the intermediate shaft is subjected to a heat treatment, in the case of which a hardness is created in the edge layer of the internal joint part, which is significantly higher than in the core of the shaft piece (DE 10 2004 062 844 B4).

The disadvantage of this method is that the bellows, which is necessary for sealing such a joint, due to the downstream hardening process, can only be assembled after the hardening process, wherein it must be mounted over the internal joint part. In particular in the area of longitudinal shafts, however, these components, which are necessary for sealing, generally do not have the necessary elasticity in order to be able to be slipped over the outer diameter of the internal joint part.

A sliding joint is also known, which is used in particular as central articulation of a longitudinal shaft of a motor vehicle and in the case of which the internal hub is embodied in one piece with a shaft journal, on which provision is made for a connection area for the releasable connection to an adjacent component as well as a sealing area for connection to a first end of a bellows. The connection of the internal joint part to a shaft section is made via a connecting sleeve, which is welded to the shaft. The connecting sleeve is slid onto the connection area of the shaft journal (WO 2008/131729 A1).

In the case of a connection arrangement of a homokinetic rotary joint comprising a shaft, it is furthermore known to weld the internal joint part to an adapter, which has means for the releasable connection to a shaft or a shaft journal. The rotary joint can thus be embodied as a basic joint, independent from the connection to shafts of any design, while the after is adapted to shafts of different designs according to the modular design principle (DE 10 2014 012 543 A1). The disadvantage of this connection arrangement lies in the higher effort required by the process steps of the production of the adapter and the pressing of a journal into the adapter as well as the safety ring assembly. In addition, the design of this connection in the context of a construction kit system is limited in that the internal joint part must always be adapted to the connecting part, e.g. a tube adapter, in spite of being connected to an adapter.

With the goal of ensuring a simple setup and the smallest possible number of components, an axially movable ball swivel joint has furthermore been developed, which is used in particular as intermediate joint in a longitudinal drive shaft for motor vehicles. The internal joint part of the ball swivel joint is connected to a molded shaft in one piece. The one end thereof, for example, is embodied as tube cross section, which is welded to an adjoining tube shaft (DE 94 14 718 U1).

### SUMMARY OF THE INVENTION

Compared to the above-mentioned prior art, the constant velocity joint according to the invention has the significant advantage that it is available in an operational manner as final assembly. This operational readiness does not only relate to the tightness of the constant velocity joint, as is already known from the prior art, but predominantly to the material characteristics of the internal joint part, such as surface hardness for a high wear resistance of the ball races and toughness for transferring the torque in particular in the area of its smallest diameter. It is also advantageous that the interface for connecting to a connecting part is located in the adapter to be welded, so that different assembly operations do not need to be performed on the internal joint part and thus on the constant velocity joint. Its construction kit function is thus fully ensured.

These advantages are attained in that a constant velocity joint, which is sealed on both sides, comprising an integral internal joint part is used.

According to the invention, the integral internal joint part is provided on its free end, which protrudes from the sealing element, with a welding attachment for accommodating an adapter and the outer diameter of this welding attachment is larger than the smallest outer diameter of the integral internal joint part. For connecting to a connecting part, the free front side of the adapter is embodied so as to be complementary to the front surface thereof. The integral internal joint part is hardened. The enlarged diameter of the welding attachment presents a softening of the hardened component when welding the adapter to the internal joint part. The size of the increase as compared to the smallest diameter of the internal joint part, in which the bellows is fastened on principle, is a function of the necessary component stability after the welding process on the one hand, and, on the other hand, is determined by the maximally permissible expansion of the elastic sealing element when being assembled on the internal joint part.

According to an advantageous embodiment of the invention, the outer diameter of the integral internal joint part is smallest in the area of the accommodation of the sealing element. The axial fit of the sealing element is thus secured, so that it only still needs to be secured against a radial expansion by means of a tightening strap.

According to an otherwise advantageous embodiment of the invention, the adapter is a tube adapter, which has a welding attachment for a tube shaft on its free front side. On principle, however, every type of connection is conceivable for a connecting part.

Compared to the above-mentioned prior art, the method according to the invention for producing a constant velocity joint comprising the characterizing features of claim 4 has the significant advantage that an operational constant velocity joint, which can readily be connected to connecting parts via an adapter and which is sealed on all sides, is available. On principle, the elastic sealing element, which seals the constant velocity joint from its internal joint side, is a bellows, but, prior to being connected to the adapter, it is mounted to the internal joint part across the welding attachment and is fastened thereto.

Costs can thus be saved in the production process of the constant velocity joint. These costs are created due to the welding, which is more cost-efficient as compared to the plug connection, the omission of components, such as the securing ring and rationalization measures by the possibility of converting a modular assembly of the constant velocity joint, among others. The advantage as compared to a non-slip traction, for example by means of a toothing, lies in that the process steps of the production of the toothing and of pressing in a journal comprising a safety ring assembly are replaced by a comparatively more cost-efficient welding process. A two-part embodiment of the internal joint part is also not required for the modularity of the connection, i.e. its use in a construction kit system, because this interface can be placed into the welding attachment, which is connected to the adapter.

Further advantages and advantageous embodiments of the invention can be gathered from the description below, from the claims and the drawings.

### BRIEF DESCRIPTION OF THE DRAWINGS

Other objects and features of the invention will become apparent from the following detailed description considered in connection with the accompanying drawings which show a preferred exemplary embodiment of the subject matter according to the invention and will be explained in more detail below. It is to be understood, however, that the drawings are designed as an illustration only and not as a definition of the limits of the invention.

In the drawings,

FIG. 1a shows a constant velocity joint according to the invention,

FIG. 1b shows a tube adapter, and

FIG. 2 shows the constant velocity joint welded to the tube adapter.

### DETAILED DESCRIPTION OF PREFERRED EMBODIMENTS

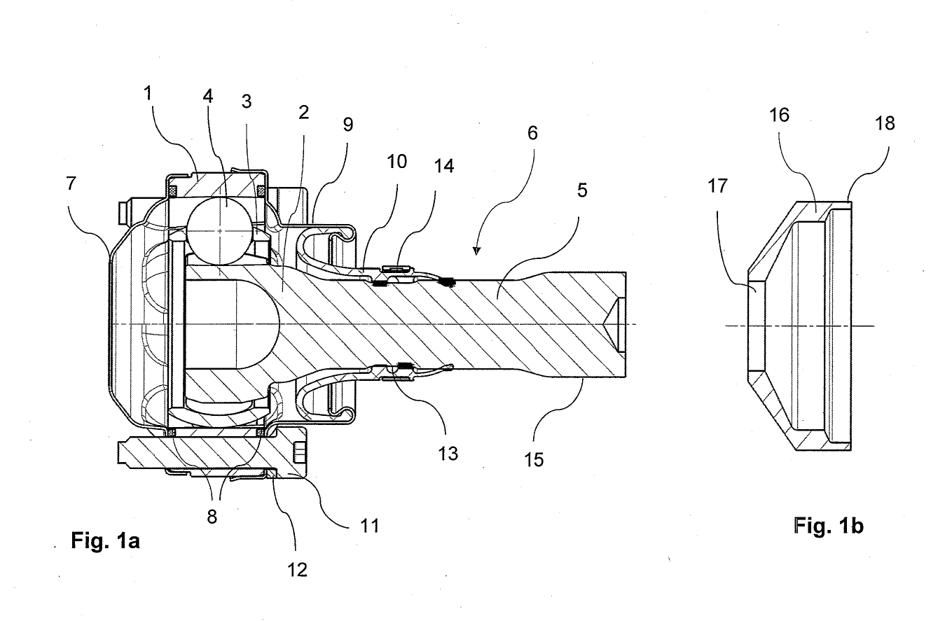

The constant velocity joint according to the invention illustrated in FIG. 1a consists of an external joint part 1, which can be flanged, and of an internal joint part 2, which is connected in a rotationally fixed manner to the external joint part 1 via balls 4 held in a cage 3. The balls 4 are thereby accommodated by internal ball tracks of the external joint part 1 as well as external ball tracks of the internal joint part 2. The internal joint part 2, together with a shaft piece 5, which is connected thereto in one piece, forms an integral internal joint part 6. On the side facing away from the internal joint part 2, the constant velocity joint is sealed by means of a closure cap 7, which rests against the external joint part 1 via a flat seal 8. On the side of the shaft piece 5 of the integral internal joint part 6, the latter is sealed by means of a sealing cap 9 and a bellows 10. The sealing cap 9 also rests against the external joint part 1 via a flat seal 8 and is screwed to the latter by means of cylinder screws 11 and washers 12. With its free front side, which is formed into a flanged edge for this purpose, the sealing cap 9 accommodates the bellows 10. With its other side, the bellows 10 is fastened by means of a tension clip 14 to the integral internal joint part 6 in a bellows seat 13, the diameter of which is reduced as compared to the outer diameter of the integral internal joint part 6. On its outer free end, the integral internal joint part 6 is provided with a diameter, which is slightly enlarged as compared to its outer diameter and which forms a welding attachment 15.

The integral internal joint part 6 can be produced from a tempering steel or a case-hardened steel. Depending on the used material, a suitable hardening method, such as induction or case-hardening can be chosen, in order to harden the edge layer of the integral internal joint part 6 across the entire axial length. On the one hand, the wear resistance in the raceways of the balls 4 is attained through this, on the other hand, the stability for transferring the torque, in particular to the smallest diameter in the area of the bellows seat 13, is ensured as well.

The constant velocity joint can be assembled for example in a joint shaft. However, it can be assembled so as to be decoupled therefrom, in that the integral internal joint part 6, the ball cage 3 and the external joint part 1 are first equipped with the balls 4. The flat seals 8, the sealing cap 9, which is provided with the bellows 10, and the closure cap are then attached from both sides, the constant velocity joint is filled with grease and the closure cap 7 and the sealing cap 9 are subsequently pressed onto the outer diameter of the external joint part 1.

The constant velocity joint, which is preassembled in this way, is subsequently welded to the integral internal joint part 6 by means of a tube adapter 16, which is illustrated in FIG. 1b and which, on its front side, which faces the integral internal joint part 6, has an opening 17, which corresponds to the diameter of the welding insert 15. In the example at hand, the tube adapter 16 is provided with a tube attachment 18 on its front side, which faces away from the integral internal joint part 6. For example friction welding, magnet arc or laser welding can be used as welding methods. In the example at hand, the joint is designed for the sliding friction welding, which is known for example from DE 10 2008 064 267 A1. As described above, the joint diameter of the welding attachment 15 is thereby chosen to be larger than the smallest diameter in the area of the bellows seat 13, in order to constructively counteract the softening of the edge layer by means of the welding process. However, the maximum expansion of the bellows 10, which must be capable of being slipped over this end of the integral internal joint part 6, as described in response to the assembly of the constant velocity joint, provides an upper limit for the diameter of the welding attachment 15. The axial distance between the bellows seat 13 and the welding attachment 15 must thereby be sufficiently large in order to protect the bellows 10 against the influence of the welding heat.

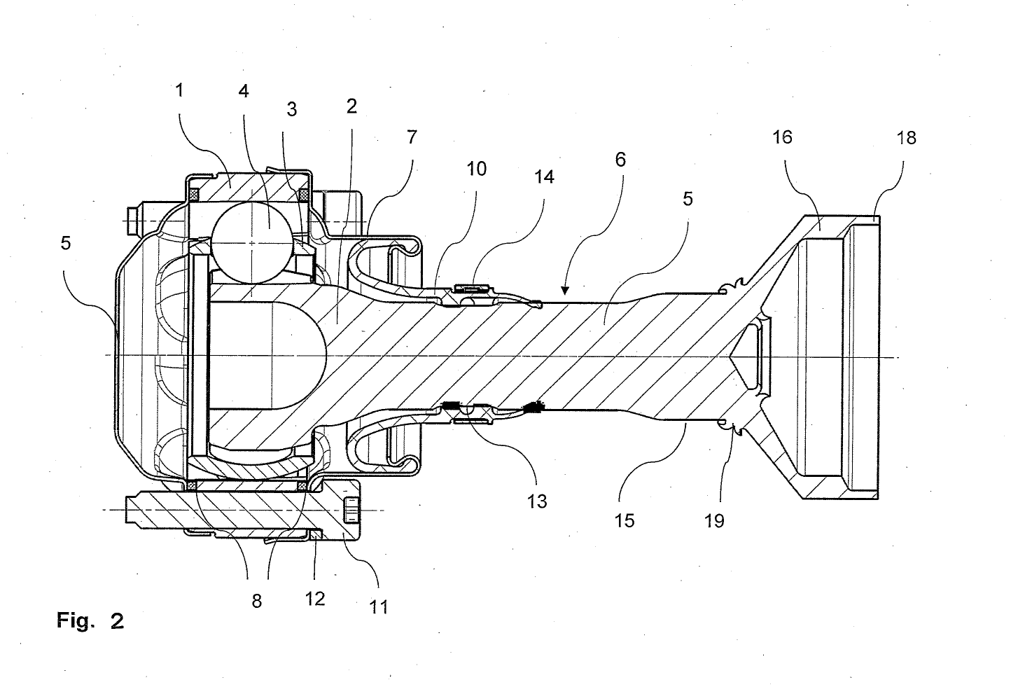

FIG. 2 illustrates the constant velocity joint, which is welded to the tube adapter 16. A welding bead 19, which is created when friction welding is used, can subsequently be removed by machining, if needed. For the further production of the joint shaft, this assembly can be joined to further partial assemblies of the joint shaft, e.g. via the tube attachment 18.

All of the features illustrated herein can be significant for the invention, both alone and in any combination with one another.

Although only a few embodiments of the present invention have been shown and described, it is to be understood that many changes and modifications may be made thereunto without departing from the spirit and scope of the invention.

### LIST OF REFERENCE NUMERALS

1 external joint part

2 internal joint part

3 ball cage

4 balls

5 shaft piece

6 integral internal joint part

7 closure cap

8 flat seal

9 sealing cap

10 bellows

11 cylinder screw

12 washer

13 bellows seat

14 tension clip

15 welding attachment

16 tube adapter

17 opening

18 tube attachment

19 welding bead

What is claimed is:

1. A constant velocity joint, comprising an external joint part (1) comprising internal ball tracks, an internal joint part (2) comprising external ball tracks assigned to the internal ball tracks, and of balls (4) held in a ball cage (3), wherein the external joint part (1) can be connected to a connecting part and is sealed by means of a closure cap (7) on the side facing this connecting part, and the internal joint part (2) is embodied as an integral internal joint part (6), which is connected to a shaft piece in a destruction-free, permanent manner and is sealed on this side towards the external joint part (1) by means of a flexible sealing element (10),
wherein, on its free end, which protrudes from the sealing element (10), the integral internal joint part (6) is provided with a welding attachment (15) for accommodating an adapter (16), wherein the outer diameter of this welding attachment (15) is larger than the smallest outer diameter of the integral internal joint part (6) and wherein the integral internal joint part (6) is hardened.

2. The constant velocity joint according to claim 1, wherein the outer diameter of the integral internal joint part (6) is smallest in the area of the accommodation of the sealing element (10).

3. The constant velocity joint according to claim 1, wherein the adapter is a tube adapter (16).

4. The constant velocity joint according to claim 2, wherein the adapter is a tube adapter (16).

5. A method for producing a constant velocity joint, comprising an external joint part (1) comprising internal ball tracks, an internal joint part (2) comprising external ball tracks assigned to the internal ball tracks, and of balls (4) held in a ball cage (3), wherein the external joint part (2) can be connected to a connecting part and is sealed by means of a closure cap (7) on the side facing this connecting part, and the internal joint part (2) is embodied as integral internal joint part (6), which is connected to a shaft piece (5) in a destruction-free, permanent manner and is sealed on this side towards the external joint part (1) by means of a flexible sealing element,
wherein, on its free end, which protrudes from the sealing element (10), the integral internal joint part (6), which is connected to the shaft piece (5), is provided with a welding attachment (15) for accommodating an adapter (6), wherein the outer diameter of this welding attachment (15) is larger than the smallest outer diameter of the integral internal joint part (6),
wherein the integral internal joint part (2) is hardened,
wherein the sealing element (10) is mounted over the end of the integral internal joint part (6), which has the smaller outer diameter, and is connected to the external joint part (1) and
wherein the adapter (16) is subsequently welded to the integral internal joint part (6) in the area of the welding attachment (15).

6. The method according to claim 5, wherein the integral internal joint part (6) is surface layer hardened.

7. The method according to claim 5, wherein the adapter (16) is welded to the prefabricated constant velocity joint only after being connected to a connecting part.

8. The method according to claim 6, wherein the adapter (16) is welded to the prefabricated constant velocity joint only after being connected to a connecting part.
